(19) United States
(12) Patent Application Publication
(10) Pub. No.: US 2002/0166801 A1
(43) Pub. Date: Nov. 14, 2002

(54) System for integrated circuit (IC) transporting of IC test device and the method thereof

(76) Inventor: Herbert Tsai, Taipei City (TW)

Correspondence Address: Herbert Tsai, PO Box 82-144, Taipei, TW

(21) Appl. No.: 09/851,556

(22) Filed: May 10, 2001

(51) Int. Cl. B07C 5/344

(52) U.S. Cl. 209/573; 209/11; 209/936

(57) ABSTRACT

The present invention relates to a system of IC transporting process for IC test device and the method thereof, and in particular, an IC transporting system having a plurality of buffering regions provided at the front end and rear end of the test region of the IC chip. The system comprises an empty tray treating region, feeding region, main buffering region, test region, and distribution region. The present invention makes use of time-differential of transporting IC chip loading trays between the distribution region and the main buffering region to maintain the testing process of IC chips. Thus, the present invention provides a high and efficient productivity.

### BACKGROUND OF THE INVENTION

(a) Field of the Invention

The present invention relates to a system for IC transporting of IC test device and the method thereof, and in particular, an IC transporting system having a plurality of buffering regions provided at the front end and rear end of the test region of the IC chip. The system comprises an empty tray treating region, feeding region, main buffering region, test region, and distribution region. The present invention makes use of tine different of transporting IC chip loading trays between the distribution region and the main buffering region to maintain the testing process of IC chips. Thus, the present invention provides a high and efficient productivity in the IC test device.

(b) Description of the Prior Art

Generally, the processes on the test platform of IC test apparatus are ignored by most of the manufactures. In the conventional method, a transportation arm is employed to obtain the IC chips from the feeding region and to transfer the chips to the test clipping head to proceed with the testing procedure. After the IC has been tested, another transportation arm is employed to transfer the chip to the tested region for collection. The drawbacks of such process and system are normally ignored but these have to be solved in order to provide high and efficient productivity. It is very common that the feeds are interrupted and the process of changing IC loading trays and sometime, the entire test region has to be stopped and the entire test process is interrupted.

### SUMMARY OF THE INVENTION

Accordingly, it is an object of the present invention to provide a system of IC transporting process for IC test device and the method thereof, wherein the entire process is divided into a plurality of buffering regions such that when the front and rear section of a certain process, for instance, the IC chip loading tray of the main buffering region moves counterclockwise, or in the process of changing loading trays, IC test can still proceed in the buffering region without stopping.

Yet another object of the present invention is to provide a system of IC transporting process for IC test device and the method thereof, wherein the buffering region can be operated independently. The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows IC chips transporting layout of the present invention.

FIG. 2 shows IC chips located at the second buffer region of the present invention.

FIG. 2A shows IC chips located at the left loading tray chip seat of the first shuttle of the present invention.

FIG. 2B shows schematically of delivery by the first shuttle and of returning by the second shuttle of the present invention.

FIG. 2C shows schematically the withdrawing of the test head from the left loading tray IC chip of the first shuttle of the present invention.

FIG. 2D shows schematically of delivery by the first shuttle and the returning of the second shuttle of the present invention.

FIG. 2E schematically shows the returning of the test head putting back the tested IC chip onto the chip tray of the present invention.

FIG. 2F shows schematically of delivery by the first shuttle and of returning by the second shuttle of the present invention.

FIG. 2G shows schematically the test head putting back the tested IC chip onto the chip seat of the present invention.

FIG. 2H shows schematically of delivery by the first shuttle and of returning by the second shuttle of the present invention.

FIG. 2I shows schematically the test head putting back the tested IC chip onto the chip seat of the first shuttle of the present invention.

FIG. 2J shows schematically of delivery by the first shuttle and of returning by the second shuttle of the present invention.

### DETAILED DESCRIPTION OF THE PRESENT INVENTION

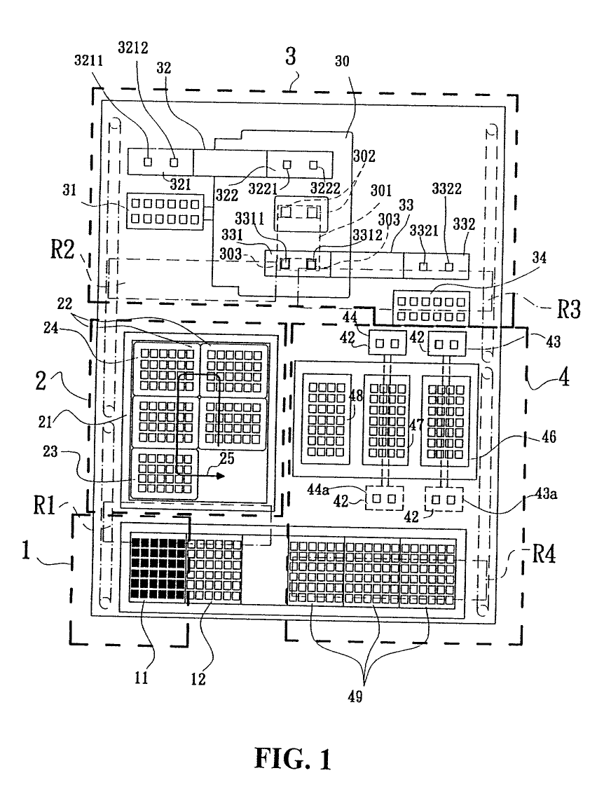

Referring to FIG. 1, there is shown a system of IC transporting process for IC test device comprising an empty tray treating region 13, a feeding region 1, a main buffering region 2, a test region 3, a distribution region 4 and IC chip transporting arms R1, R2, R3, R4 located around the individual regions, wherein

(a) the empty tray treating region 13 includes a plurality of stacked IC chip trays 13;

(b) the feeding region 1 includes testing IC chips a within the IC chip loading tray 11;

(c) the main buffering region 2 includes a large square tray 21 having five similar size IC chip loading trays 22 and the five similar size IC chip trays 22 can be rotated counterclockwise direction 25 and can be heated so that the IC chips thereto are also heated;

(d) the test region 3 includes a test platform 30 having a test seat 301 with two rows (altogether 4) of test clipping heads 302, 303, and having half a shuttle width and two shuttles are arranged alternately as first shuttle and a second shuttle in a left and right position respectively and are in parallel passed through the front and rear side of the test platform 30, the test platform 30 can move from front to back, between the first 32 and the second shuttle 33, and the left side of the two shuttles 32,33 is provided with a second buffering region 31 which can contain a plurality of IC chips;

(e) the distribution region 4 includes a third buffering region 34 and two loading tray 43, 44, three distribution trays 46, 47, 48 and three IC chip trays 49 for testing ICs;

(f) IC chip transporting arms R1, R2, R3, R4 include a first IC chip transporting arm R1 to shift the testing IC chips a from the feeding region 1 to the inlet region 23 of the main buffering region 2, a second IC chip transporting arm R2 to shift the IC chips a from the accessing region 24 of the main buffering region 2 to the second buffering region 31 or the chip seat 3211, 3212, 3311, 3312 of the left loading trays 321, 331 of the first shuttle 32 or the second shuttle 33, a third IC chip transporting arm R3 to access the tested IC chips on the right loading tray of the first shuttle 32 and the second shuttle 33 to the third buffering region 34 or the tray 42; and a delivery forth IC chip transporting arm R4 to shift the tested IC chips within the delivery tray 42 to the fixed distribution tray 46, 47, 48 or the stacked IC chip loading trays 49.

In accordance with the present invention, the process of IC chips transportation is as follows:

(1) placing the testing IC chip a layers stacked on the IC chip loading tray 11 of the feeding region 1;

(2) shifting the testing IC chips a by the first IC chip transporting arm RI to the IC chip loading tray 22 of the inlet region 23 of the main buffering region 2 which can be appropriately heated, after the IC chip loading tray 22 is loaded and moves a step in a counterclockwise direction;

(3) accessing the IC chips by the second IC chips transporting arm R2 to the second buffering region 31 after the IC chip loading tray 22 is moved to the position of accessing region 24;

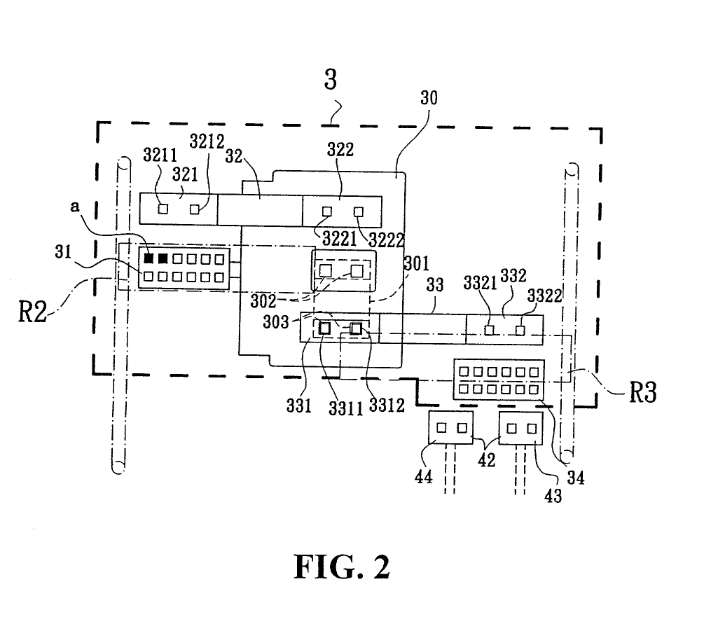

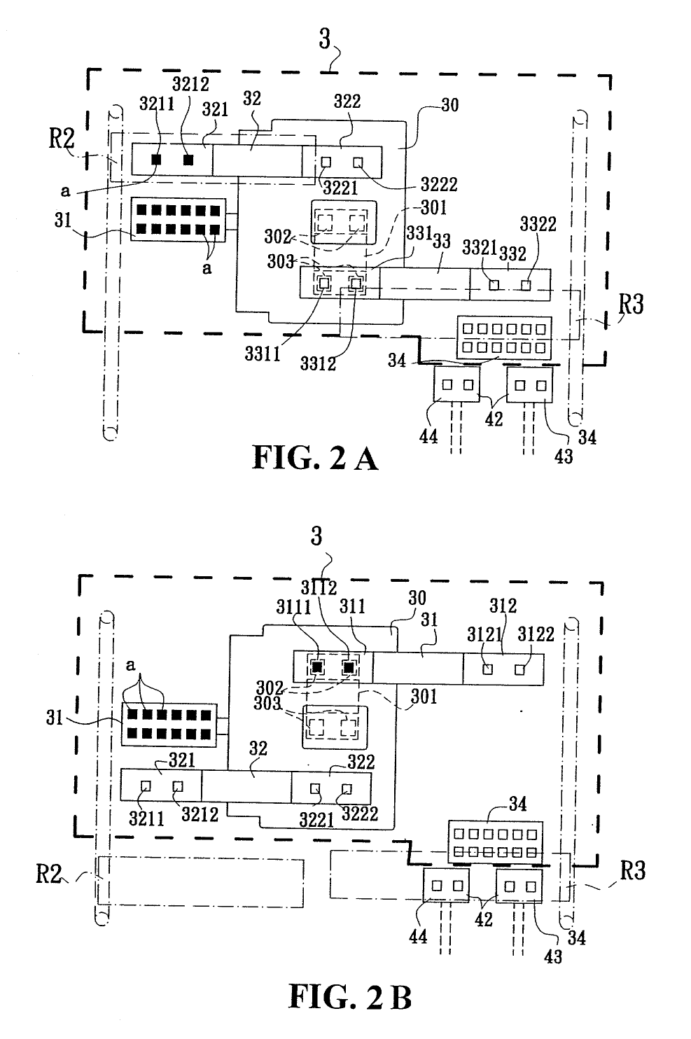

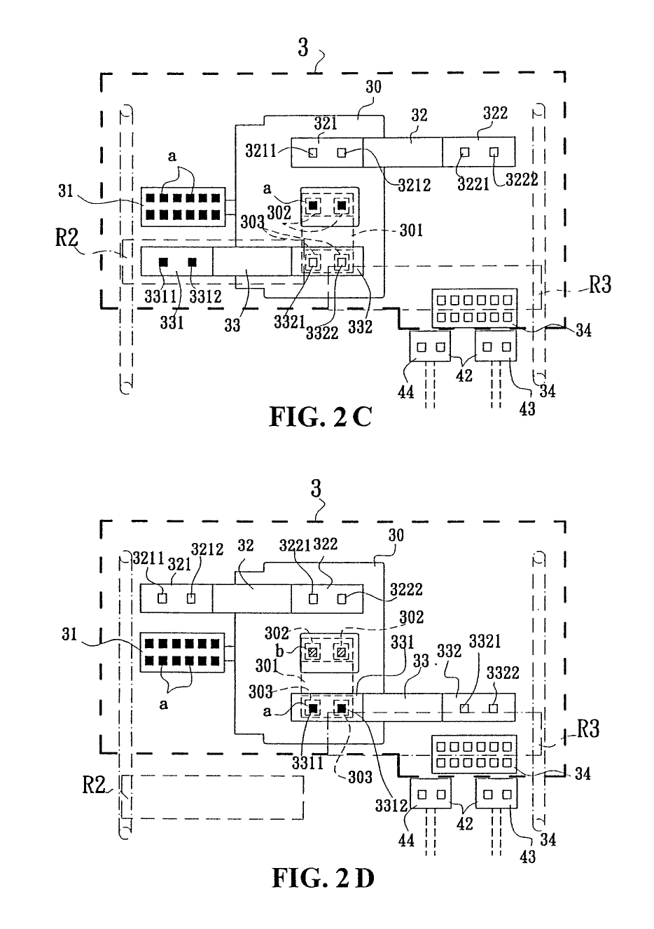

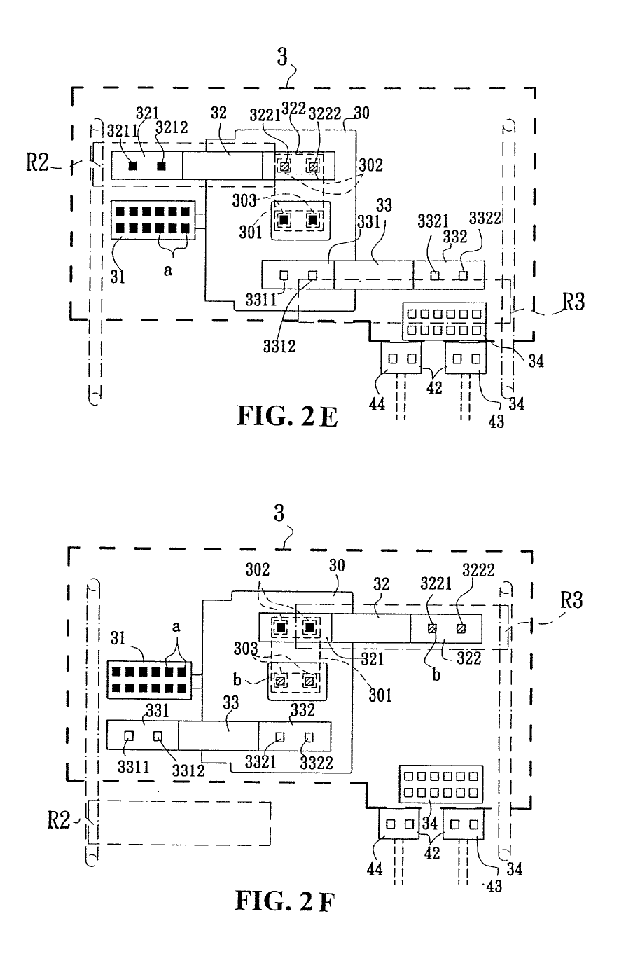

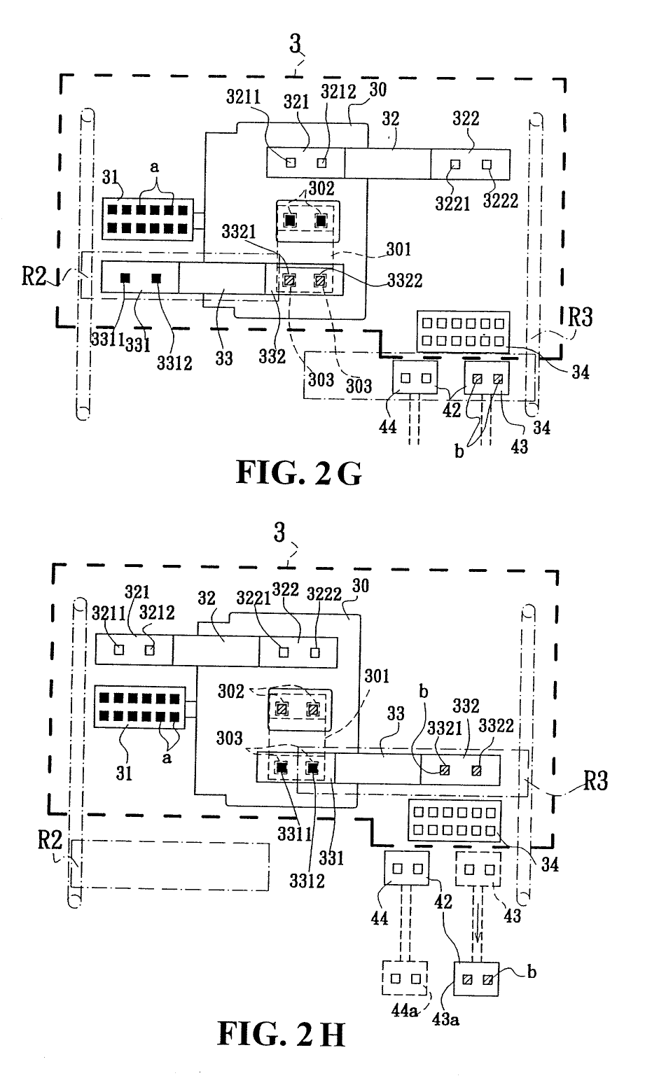

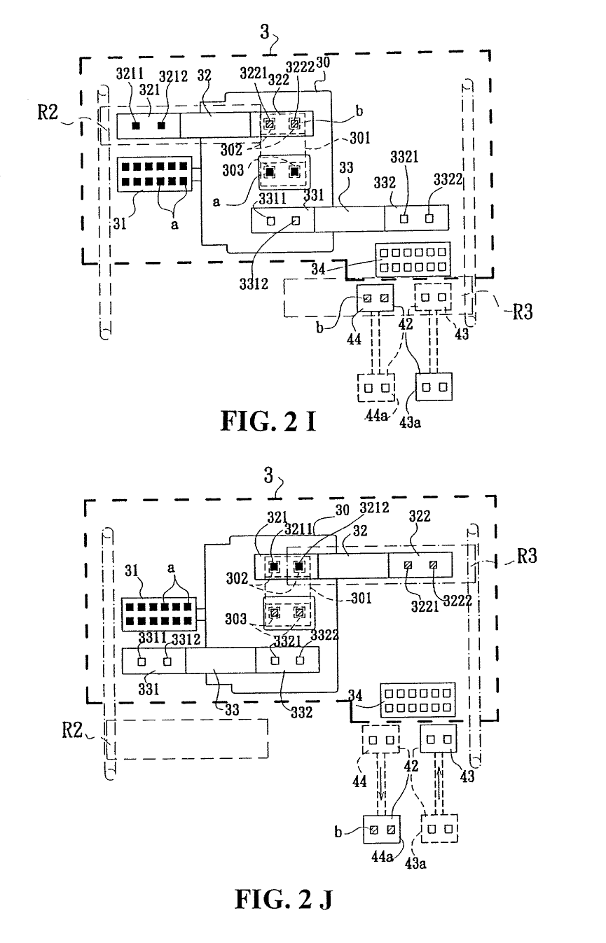

(4) placing the IC chips onto the left loading tray 321 of the first shuttle 32 (shown in FIG. 2A) after the second shuttle buffering region 31 is filled with IC chips;

(5) accessing two IC chips by the second IC chip transporting arm R2 at the accessing region 24 and returning the first shuttle and the second shuttle (shown in FIG. 2B);

(6) placing IC chips onto the second shuttle 33 left loading tray 331 by the second IC chip transporting arm R2 and accessing two chips from the first shuttle 32 left loading tray 321 by the test clipping head 302 of the test seat 301 and lowering it to the center position for testing, the other test clipping head 302 being at the top of the right loading tray 332 of the second shuttle 33 (shown in FIG. 2C);

(7) accessing two IC chips from the accessing region 24 of the main buffering region 2 by the second IC chip transporting arm R2 and proceeding to IC test by the test clipping head 302, and returning the first shuttle 32 and the second shuttle 33 (FIG. 2D);

(8) accessing the IC chip by the test clipping head 303 from the second shuttle 33 left loading tray 331 to proceed with testing, moving the test seat 301 upward so that the test clipping head 302 places the tested IC chips into the right loading tray 322 of the first shuttle 32, and placing IC chips into the first shuttle 32 left loading tray 321 by the second IC chip transporting arm 22 (shown in FIG. 2E);

(9) returning the second IC chip transporting arm R2 to the main buffering region 2 to access two IC chips and the test clipping head 303 to proceed with IC chip test, and returning the first 32 and the second shuttle 33 (shown in FIG. 2F);

(10) accessing the IC chip by the test clipping head 302 being moved to the first shuttle 32 left loading tray 321, lowering the test seat 301 so that the tested IC chips are placed onto the second shuttle 33 right loading tray 332 and placing the IC chips by the second IC chip transporting arm R2 onto the second shuttle 33 left loading tray 331 and accessing the IC chips on the first shuttle 32 right loading tray 322 by the third IC chip transporting arm R3 to the moving tray initial delivery point 43 of the delivery tray 42 (shown in FIG. 2G);

(11) returning the second IC chip transporting arm R2 to the accessing region 24 of the main buffering region 2 to access two IC chips and test clipping head 302 and returning the first 32 and the second shuttle 33, and transporting the delivery tray 42 at the moving tray initial delivery point 43 to the moving tray ending point 43a (shown in FIG. 2h);

(12) accessing IC chip by the test clipping head 303 to the second shuttle 33 left loading tray 331 and moving the test seat 301 upward such that the tested IC chips are placed onto the first shuttle 32 right loading tray 322, and placing the IC chip onto the fist shuttle 32 left loading tray 321 by the second IC chip transporting arm R2, and accessing the IC chips on the second shuttle 33 right loading tray 332 by the third IC chip transporting arm R3 to the moving tray initial delivery point 44 of the delivery tray, and accessing the tested IC chips from the moving tray delivery end point 43a by the forth IC chip transporting arm R4, the tested IC chips b are classified into three fixed distribution trays 46, 47, 48 or stacked onto the IC chips tray 49 (FIG. 2I);

(13) returning the second IC chip transporting arm to the accessing region 24 of the main buffering region 2 to access two IC chips and proceeding to IC test by the test clipping head 303 and returning the first 32 and the second shuttle 33, delivering the delivery tray 42 from the initial delivery point 44 to the ending point 44a, and the other delivery tray 42 being delivered from the ending point 43a to the initial point 43 (shown in FIG. 2J); and

(14) accessing the tested IC chips b at the ending point 44a by the forth IC chip transporting arm R4 and classifying the result of test to three fixed distribution trays 46, 47, 48 or stacked onto the IC chip trays 49 and repeating from step 10.

In view of the above, the first shuttle 32 and the second shuttle 33 left loading tray 321, 331 directly access the IC chips from the main buffering region 3, and if the second IC chip transporting arm R2 cannot access the IC chips from the main buffering region, a program can command the second buffering region 31 to access the IC chips without waiting, and if the IC chips loading tray is changed and cannot provide IC chips a program can command the third IC chip transporting arm R3 to access the tested IC chip to be placed at the third buffering region 34 so that the third IC chip transporting arm R3 can move without stopping.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

1. A system of IC transporting process for IC test device comprising an empty tray treating region, a feeding region, a main buffering region, a test region, a distribution region and IC chip transporting arms located around the individual regions, wherein
(a) the empty tray treating region includes a plurality of stacked IC chip trays;
(b) the feeding region includes testing IC chips within the IC chip loading tray;
(c) the main buffering region includes a large square tray having five similar size IC chip loading trays and the five similar size IC chip trays can be rotated counterclockwise direction and can be heated so that the IC chips thereto are also heated;
(d) the test region includes a test platform having a test seat with two rows (altogether 4) of test clipping heads, and having half a shuttle width and two shuttles are arranged alternately as first shuttle and a second shuttle in a left and right position respectively and are in parallel passed through the front and rear side of the test platform, the test platform can move from front to back, between the first and the second shuttle, and the left side of the two shuttles is provided with a second buffering region which can contain a plurality of IC chips;
(e) the distribution region includes a third buffering region and two loading tray, three distribution trays and three IC chip trays for testing;
(f) IC chip transporting arms includes a first IC chip transporting arm to shift the testing IC chips from the feeding region 1 to the inlet region of the main buffering region, a second IC chip transporting arm to shift the IC chips a from the accessing region of the main buffering region to the second buffering region or the chip seat of the left loading tray of the first shuttle or the second shuttle, a third IC chip transporting arm to access the tested IC chips on the right loading tray of the first shuttle and the second shuttle to the third buffering region or the tray; and a delivery forth IC chip transporting arm to shift the tested IC chips within the delivery tray to the fixed distribution tray or the stacked IC chip loading trays.

2. A method of IC transporting process of a IC test device as set forth in claim 1 comprising the steps of
(a) placing the testing IC chip A stacked layers stacked on the IC chip loading tray of the feeding region;
(b) shifting the testing IC chips by the first IC chip transporting arm to the IC chip loading tray of the inlet region of the main buffering region which can be appropriately heated, after the IC chip loading tray is loaded and moves a step in a counterclockwise direction;
(c) accessing the IC chips by the second IC chips transporting arm to the second buffering region after the IC chip loading tray is moved to the position of accessing region;
(d) placing the IC chips onto the left loading tray of the first shuttle after the second shuttle buffering region is filled with IC chips;
(e) accessing two IC chips by the second IC chip transporting arm at the accessing region and returning the first shuttle and the second shuttle;
(f) placing IC chips onto the second shuttle left loading tray by the second IC chip transporting arm and accessing two chips from the first shuttle left loading tray by the test clipping head of the test seat and lowering to the center position for testing, the other test clipping head being at the top of the right loading tray of the second shuttle;
(g) accessing two IC chips from the accessing region of the main buffering region by the second IC chip transporting arm and proceeding to IC test by the test clipping head, and returning the first shuttle and the second shuttle;
(h) accessing the IC chip by the test clipping head from the second shuttle left loading tray to proceed with testing, moving the test seat upward so that the test clipping head places the tested IC chips into the right loading tray of the first shuttle, and placing IC chips into the first shuttle left loading tray by the second IC chip transporting arm;
(i) returning the second IC chip transporting arm to the main buffering region to access two IC chips and the test clipping head to proceed with IC chip test, and returning the first and the second shuttle;
(j) accessing the IC chip by the test clipping head being moved to the first shuttle left loading tray, lowering the test platform so that the tested IC chips are placed onto the second shuttle right loading tray and placing the IC chips by the second IC chip transporting arm onto the second shuttle left loading tray and accessing the IC chips on the first shuttle right loading tray by the third IC chip transporting arm to the moving tray initial delivery point of the delivery tray 42;
(k) returning the second IC chip transporting arm to the accessing region of the main buffering region to access two IC chips and test clipping head and returning the first and the second shuttle, and transporting the delivery tray at the moving tray initial delivery point to the moving tray ending point;
(l) accessing IC chip by the test clipping head to the second shuttle left loading tray and moving the test platform upward such that the tested IC chips are placed into the first shuttle right loading tray, and placing the IC chip onto the first shuttle left loading tray by the second IC chip transporting arm, and accessing the IC chips on the second shuttle right loading tray by the third IC chip transporting arm to the moving tray initial delivery point of the delivery tray, and accessing the tested IC chips from the moving tray delivery end point by the forth IC chip transporting arm, the tested IC chips are classified into three fixed distribution trays or stacked onto the IC chips tray;
(m) returning the second IC chip transporting arm to the accessing region of the main buffering region to access two IC chips and proceeding to IC test by the test clipping head and returning the first and the second shuttle, delivering the delivery tray from the initial delivery point to the ending point, and the other delivery tray being delivered from the ending point to the initial point; and
(n) accessing the tested IC chips at the ending point by the forth IC chip transporting arms and classifying the result of test to three fixed distribution trays or stacked onto the IC chip trays and repeating from step j;
thereby, the first shuttle and the second shuttle left loading tray directly access the IC chips from the main buffering region, and if the second IC chip transporting arm cannot access the IC chips from the main buffering region, a program can command the second buffering region to access the IC chips without waiting, and the IC chips loading tray is changed and cannot provide IC chips a program can command the third IC chip transporting arm to access the tested IC chip to be placed at the third buffering region so that the third IC chip transporting arm can move without stopping.
